(19) United States
(12) Patent Application Publication
(10) Pub. No.: US 2004/0056763 A1
(43) Pub. Date: Mar. 25, 2004

(54) Method for protecting against theft of auto tires

(76) Inventors: Martin Fischer, Regensburg (DE); Dominik Fussel, Dietzenbach (DE); Franz Hillenmayer, Burglengenfeld (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/610,600

(22) Filed: Jul. 1, 2003

(30) Foreign Application Priority Data
Jul. 2, 2002 (DE) 10229677.4

(51) Int. Cl. B60R 25/10

(52) U.S. Cl. 340/426.1

(57) ABSTRACT

The invention relates to a method for preventing the theft of auto tires in which (with the vehicle stationary) at least one parameter of a characteristic of a coil positioned in the area of a tire in each case, especially in the wheel bay, is monitored, and an alarm is triggered when the parameter changes. Furthermore the invention relates to a device for executing such a method.

### PRIORITY

This application claims foreign priority of the German application DE10229677.4 filed Jul. 2, 2002.

### TECHNICAL FIELD OF THE INVENTION

The invention relates to a method and also a device/system for preventing the theft of auto tires.

### BACKGROUND OF THE INVENTION

Previously automotive engineering has only made the theft of auto tires more difficult under some circumstances. This has been done by protecting some wheels, especially expensive alloy wheels, against unauthorized access with special locking wheel bolts, which can only be released by a special key for example.

Since however such wheels are also produced in large numbers and since the keys can also be obtained separately, this only gives very unsatisfactory protection against unauthorized removal of the wheel with other keys or duplicate keys.

### SUMMARY OF THE INVENTION

The object of the present invention is to create a method for protecting auto tires against theft as well as a device for executing such a method, which makes unauthorized removal of the auto tires more difficult or indeed prevents it.

This object is achieved in accordance with the invention by using a method with the following features: monitoring at least one parameter of a characteristic of a coil, and initiating an alarm if the monitored parameter changes.

It involves providing in the vicinity of the tire, for example in the wheel bay, a coil for which the parameters of the characteristics of a coil (inductivity, reactance etc.) depend on the metal content of the tire (steel belt) and specially of the wheel. By monitoring a change in the at least one parameter unauthorized removal or dismantling can be detected and an alarm, for example audible and/or visual, can be triggered.

In an advantageous embodiment of the invention this involves at least one parameter being interrogated at intervals (typically every thirty seconds or more frequently) to avoid running down the auto battery unnecessarily. Furthermore it is conceivable to link a tire anti-theft system with any other normal anti-theft system that the vehicle may have with a proximity sensor or, if the vehicle does not have such a system, to install such a proximity sensor as an extra, to reduce the intervals or even to activate or to start the interrogation of the at least one parameter.

For technical implementation of this type of detector device or of an electrical circuit to interrogate or to monitor at least one coil parameter there are a number of options available to an expert. For example a frequency-dependent element such as a tunable filter, a band pass or similar can be used to detect the resonant frequency of a AUSO1:318006.1 harmonic circuit consisting the coil and a capacitance (possibly fitting of an additional capacitor).

It is also conceivable for the transmitted resonant frequency of such a harmonic circuit to be received inductively by the receiver within a desired bandwidth.

In this case a change of at least one parameter, such as for example the resonant frequency directly dependent on the inductance of a coil, can be detected directly or indirectly and a corresponding alarm triggered to prevent a theft of the tire or tires.

In the preferred embodiment of the invention this monitoring is only undertaken when the vehicle is parked and if necessary locked so as to exclude an undesired alarm when a tire is intentionally being changed. This can be coupled for example to activation of monitoring by a meaningful event of a locked vehicle, such as operating the central locking system for example.

In a further preferred embodiment of the invention an existing low-frequency antenna will be used as a coil that is already available on the vehicle in the vicinity of a tire, but is used for another function, such as monitoring tire pressure while driving for example (when the vehicle is unlocked).

This advantageously reduces the technical effort required to implement the method in accordance with the invention as well as a device for executing such a method.

### BRIEF DESCRIPTION OF THE DRAWINGS

The invention is described in more detail below using an exemplary embodiment illustrated in the drawing. The drawing shows:

FIG. 1 a schematic diagram of part of a vehicle with the anti-theft device for auto tires in accordance with the invention.

### DETAILED DESCRIPTION OF THE PREFERRED EMBODIMENTS

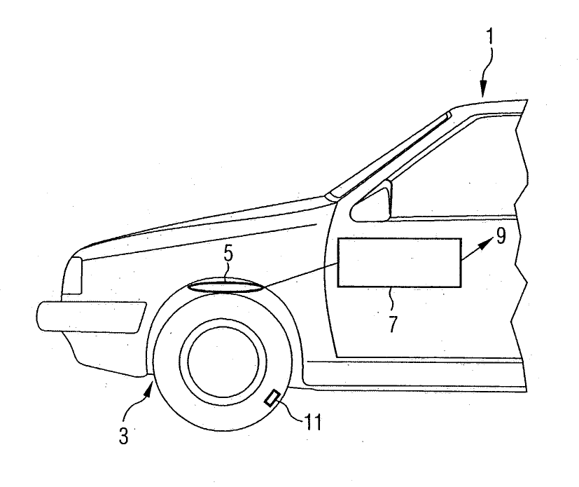

As shown schematically in FIG. 1, the wheel compartment 3 of a vehicle 1 contains a coil in the form of a low-frequency antenna 5 which is connected to a detector unit 7. Antenna 5 can already be present in the system in this case, for example, as part of a tire pressure monitoring system, to transfer the information of a pressure sensor 11 located on or in the tire.

The detector unit 7, which can also include a control and evaluation unit, is additionally linked to other systems in the vehicle, such as the central locking 9.

If a vehicle is now parked and locked, the detector unit 7 is activated by the state “Central locking locked” and at intervals interrogates the inductance or a value directly dependent on it.

For this purpose a capacitor can be connected to antenna 5 so that a harmonic circuit is produced for which the resonant frequency or the change in it can be monitored via a corresponding circuit (network, tuning filter, band pass etc).

If there is an unauthorized attempt to remove a wheel the metal content which is effective in the vicinity of the inductance or of the antenna changes, since both tires (steel belt) and wheels are at least partly composed of metal. In accordance with known physical laws this results in a change in the inductance of antenna 5 and its associated parameter (reactance, etc.).

A change of this type is registered by the detector unit however and triggers an alarm, for example through a connection to the vehicle lights (interior lighting and/or headlights, horn and such like).

Of course it is an advantage to have an antenna 5 fitted in each wheel bay 3 in order to protect each wheel against theft. The detector unit 7 can be present more than once, i.e. for each tire, and be linked to other vehicle functions, for example via a central control unit not shown in the drawing. It is also conceivable for only a single detector unit to be located centrally in the vehicle and for it to be connected to all tires or antennas 5.

Although the use of antennas 5 already present in the vehicle advantageously minimizes the constructional effort involved in executing or implementing the method in accordance with the invention or to implement a tire anti-theft system in accordance with the invention, it is of course also conceivable to equip vehicles without any other tire functions, for example monitoring the tire pressure when the vehicle is ready to be driven, with this type of anti-theft device.

Even retrofitting to vehicles already on the market is conceivable and in the case of vehicles which already have tire pressure monitoring or checking systems, it is particularly easy. However retrofitting to vehicles without an appropriate antenna 5 in the wheel bay is not impossible since fitting the corresponding upgrade kits available from the trade with antennas 5 and detector unit 7 is certainly not beyond the capabilities of hobbyists or workshops.

What is claimed is:

1. A method for protecting tires on an auto against theft, said method comprising:
a) monitoring, while the vehicle is stationary, at least one parameter of a characteristic of a coil positioned in the area of the tire, and
b) initiating an alarm, if said parameter changes.

2. The method according to claim 1, wherein the at least one parameter is monitored at intervals.

3. The method according to claim 1, further comprising the step of forming from the coil and a capacitor a harmonic circuit having a resonant frequency, said frequency being a parameter monitored.

4. The method according to claim 2, wherein a resonant frequency of a harmonic circuit formed from the coil and a capacitor is monitored as a parameter.

5. The method according to claim 1, wherein the at least one parameter is only monitored when the vehicle is locked.

6. The method according to claim 2, wherein the at least one parameter is only monitored when the vehicle is locked.

7. The method according to claim 1, wherein the at least one parameter of the characteristic of the coil is monitored by a detector unit.

8. The method according to claim 3, wherein the coil is connected in parallel with the capacitor.

9. The method according to claim 3, wherein the coil is connected in series with the capacitor.

10. The method according to claim 1, wherein an antenna already present in the vehicle to perform other functions is used as the coil.

11. The method according to claim 1, wherein the coil is positioned in the area of the wheel bay.

12. A system for protecting a tire on an auto from theft, said system comprising:
a coil positioned on the auto in the area of the tire; and
a detector in communication with said coil, wherein the detector monitors, while the vehicle is stationary, at least one parameter of a characteristic of said coil.

13. The system according to claim 12, further comprising a capacitor in communication with said coil.

14. The system according to claim 13, wherein the capacitor and coil form a harmonic circuit and the at least one parameter of a characteristic of the coil monitored is the resonant frequency of said harmonic circuit.

15. The system according to claim 13, wherein the capacitor is in serial or parallel communication with said coil.

16. The system according to claim 12, wherein the coil is positioned in the area of the wheel bay.

17. The system according to claim 12, wherein an antenna already present in the auto for performing another function is used as the coil.

18. The system according to claim 12, further comprising an alarm that is activated if the at least one parameter of a characteristic of the coil changes.

19. The system of claim 12, wherein the detector only monitors when the auto is locked.

20. The system of claim 12, wherein the detector monitors in intervals.

21. The system of claim 12 further comprising (a) an alarm in communication with said detector, said alarm activatable upon a detected change in the parameter, and (b) a capacitor in serial or parallel communication with said coil, said capacitor and coil forming a harmonic circuit having a resonant frequency monitored in intervals when the auto is locked, by said detector, wherein the coil is (a) an antenna already present in the auto for performing another function, and (b) located in the wheel bay of the auto.
